(19) United States
(12) Patent Application Publication
(10) Pub. No.: US 2008/0168017 A1
(43) Pub. Date: Jul. 10, 2008

(54) METHOD AND APPARATUS FOR CONFIGURATION MODELLING AND CONSISTENCY CHECKING OF WEB APPLICATIONS

(75) Inventors: Vugranam C. Sreedhar, Yorktown Heights, NY (US); Dana Glasner, New York, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,143

(22) Filed: Jan. 5, 2007

(51) Int. Cl. G06N 5/02; G06F 9/44

(52) U.S. Cl. 706/47; 703/21

(57) ABSTRACT

A method, system and article are provide for treating consistency checking of a configuration of an information technology system by developing a model of the configuration based on common criteria functional requirements, extending the common criteria to model the configuration, imposing a set of constraints on the configuration model, converting the system configuration to a model instance, and verifying that the model instance satisfies the set of constraints.

### BACKGROUND OF THE INVENTION

1. Field of the Invention

This invention relates to configuration of internet website infrastructures and applications, and particularly to a method and apparatus for defining consistency checking rules and ontology for modeling configuration of internet website applications.

2. Description of Background

Configuration plays a central role in deployment and management of internet website (hereinafter, “Web”) applications and infrastructures. Web applications and infrastructures are often susceptible to malicious attacks. A default configuration almost always leads to security and performance problems. For example, in the year 2000, the Apache Website (www.apache.org) was defaced because of a simple configuration error made by experienced system administrators. A recent report concluded that 65% of attacks are due to poorly configured or mis-configured systems. “Taxonomy of Software Vulnerabilities”, J. Pescatore, Gartner, Inc., 11 Sep. 2003. Notably, only 5% of attacks were due to previously unknown flaws. Id.

Configuring infrastructures and applications is a very complex process and is currently not guided by an accepted theory. Configuring a Web application typically involves many steps, including setting many different configuration parameters. Understanding the consistency of different configuration parameters can be overwhelming. Also, often a system administrator has to deal with configuring many different and interacting Web applications and runtime environments. For instance, the configuration of the Apache Web server may interact with the configuration of modules, such as the PHP (PHP:Hypertext Preprocessor) module or SSL (Secure Socket Layer) module which are plugged into the Apache server. Such configuration interaction is even more pronounced in high-volume data centers. Also in data centers, configurations of different data center sub-systems are done by different people over a period of time.

Accordingly, a systematic approach for configuration modeling and consistency checking of Web applications and servers is desired.

### SUMMARY OF THE INVENTION

The shortcomings of the prior art are overcome and additional advantages are provided through the provision of a method for treating consistency checking of a configuration of an information technology system where the method includes developing a model of the configuration based on common criteria functional requirements, extending the common criteria to model the configuration, imposing a set of constraints on the configuration model, converting the system configuration to a model instance, and verifying that the model instance satisfies the set of constraints.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides a simplified and expeditious approach for modeling configuration of internet infrastructures and applications.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a main class hierarchy of a Tbox for an Apache configuration.

The detailed description explains the preferred embodiments of the invention, together with advantages and features, by way of example with reference to the drawings.

### DETAILED DESCRIPTION OF THE INVENTION

Herein, a systematic approach is provided for modeling a configuration of a web application. As an example of the invention, the configuration of the Apache Web Server (www.apache.org) is modeled.

A framework for such modeling comprises Configuration Rules and Ontology for Web (hereinafter sometimes referred to as, “CROW”). CROW uses a Web Ontology Language framework (hereinafter sometimes referred to as, “OWL”). OWL is a language for describing ontology where ontology is generally a formal description of concepts and their relations.

There are three exemplary embodiments of OWL. The first is OWLLite which only supports taxonomy with simple constraints. The second embodiment of OWL is OWL-DL which is a SHOIN(D) decidable fragment of DL. The third exemplary embodiment of OWL is OWL-Full which supports the full generality of Resource Description Framework Schema (hereinafter sometimes referred to as, “RDFS”). In general, OWL-Full is undecidable. Herein, CROW utilizes OWL-DL as a starting point for modeling configurations.

A model in OWL comprises a Terminological Box and an Assertion Box (hereinafter sometimes referred to as, “Tbox” and “Abox”, respectively). A Tbox contains classes and relationships between classes including, for example, restrictions on classes (such as two classes that are defined to be disjoint) and the relations between those concepts. An Abox contains assertions about specific instances that can relate an instance to a class or relate two instances with each other.

The main Apache configuration file httpd.conf, discussed herein by way of example, is a plain text file which simply contains a laundry list of directives. A directive, in this sense, is a “command” or an “instruction” to the Apache runtime to respond or behave in a certain, i.e., directed, way. There is no inherent structure to the content of the Apache configuration file. Thus, to induce structure, terminologies are utilized from the Common Criteria international standard (ISO/IEC 15408).

As is known, the Common Criteria (sometimes hereinafter referred to as, “CC”) is a standard for specifying, developing and evaluating security requirements of a system. The CC evaluation process begins by identifying the target of evaluation (TOE), which is a system under evaluation. With respect to a TOE, the CC standard identifies three main concepts: subjects, objects, and external users. Within the Apache httpd.conf file, directives are identified that influence the subject, object, and user aspect of the Apache server. Then, these classes are constructed that specialize these concepts and create the Tbox for CROW. Next, the consistency checking rules are defined based on best practices and other expert recommendations for hardening an Apache server deployment. Such consistency checking rules are encoded as A-box in OWL-DL. Using T-box and A-box the structure of the configuration files are defined along with the interactions of subjects and objects within the environment, and constraints and rules which are desired to be enforced on the model. Having established the T-box and A-box models, the invention then checks for consistency of the configuration instances of a deployment.

Pure OWL-DL sufficiently and naturally expresses most cases of consistency rules and best practices. For those cases which cannot be sufficiently expressed, OWL-DL-Safe rules are employed. OWL-DL-Safe rules combine OWL-DL and function-free Horn rules (clauses) by ensuring that every variable in a rule occurs in a non-DL atom. The OWL-DL-Safe rule is decidable and is more expressive than both OWL-DL and function free Horn rules.

Herein, implementation of CROW, including T-box, Abox, and DL-Safe rules, is accomplished by using an open source tool for modeling OWL ontology such as, for example, a tool known commercially as Protege. CROW, as described herein, comprises 60 classes in Tboxes, 15 constraints on classes, 55 properties with constraints, 500 elements in A-boxes and 3 DL-Safe rules. A check for consistency of the configuration instance is provided by OWL reasoner, Pellet reasoner for Abox, and Jess OWL-safe rules. A Perl script is utilized that converts the elements of the configuration file (i.e., the content of http.conf of a particular installation) into OWL instances that can be read by the Protege tool. The Pellet reasoner and Jess Rule Engine are then used to check for consistency of the configuration instance.

As discussed further in detail herein, the invention presents the framework of CROW for defining consistency checking rules and ontology for modeling configuration of Web applications, including, by example, the Apache Web server. The invention classifies configuration parameters, including directives, in such a way that they correspond to the CC terminology made up of subjects, objects and external users. As also discussed herein, the CROW, based on formal description logic and off-the-shelf reasoners, and standard (OWL) language are used for modeling configurations and checking for consistencies. The broad scope of the invention further extends beyond description logic and uses OWL-Safe rules to deal with best practices that cannot naturally be expressed in pure OWL DL.

Turning now to the language of the invention, it is noted that OWL is a language for describing ontologies and an ontology is a model of the domain of a discourse with reasoning capabilities on the objects and their relationships in the domain. OWL can be used for modeling any domain of discourse. In this exemplary embodiment of the invention, the domain of discourse is the Apache configuration. Of the three increasingly expressive sublanguages of OWL, OWL Lite has very limited expressiveness and is used mainly for creating taxonomies and hierarchical relations. It is a sublanguage of OWL DL, which is named so because it corresponds to SHOIN(D), a type of Description Logic and is guaranteed to be decidable. OWL Full is more expressive than OWL DL. For example, in OWL Full, an entity can be both a class and an individual simultaneously. In general, OWL Full is not guaranteed to be decidable. Herein, OWL DL is utilized.

As mentioned, Protégé is used herein for creating the OWL ontologies. (It is noted that, for simplicity, Protégé OWL notation is used throughout this description.) An OWL ontology is made of instances (also called as individuals), properties, and classes. Instances are objects in a domain of discourses that are being modeled. In the case of Apache configuration, OWL instances may be file names, port numbers, server name, etc. Properties are binary relations on instances which essentially link two instances. A property can be an inverse of another property. A property can be defined to be functional, i.e., a single valued property. Classes are sets of instances in the domain of discourse. Classes in OWL are related with one another in a hierarchical relation. A sub-class specializes a super-class (or a super-class subsumes a sub-class). By default, classes in OWL overlap, i.e., an instance can be a member of more than one class. One can define two classes to be disjoint, in which case an instance cannot be a member of both classes.

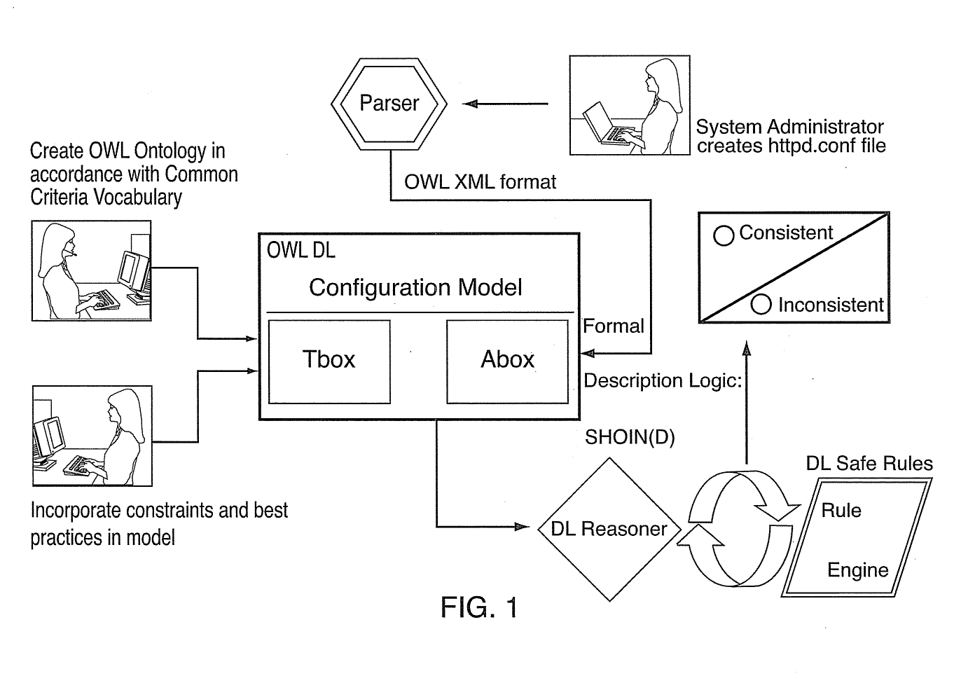

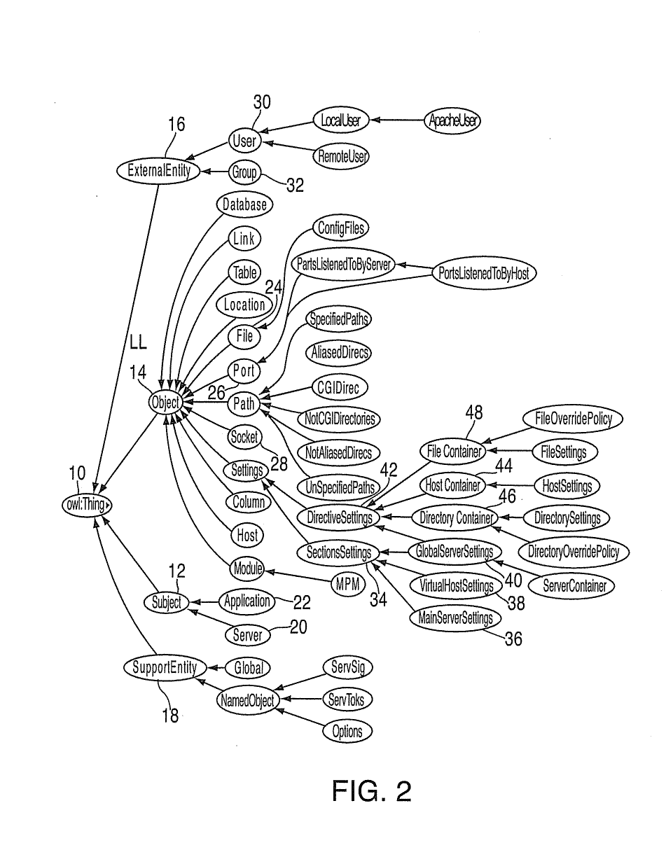

As mentioned, a model in OWL is made of Terminological Box (Tbox) and Assertion Box (Abox). With reference to FIG. 1, the Tbox and Abox are both used to make inferences on the model and to check for consistencies using a reasoner. The Pellet reasoner is used which has a DIG interface and therefore can communicate with Protégé. Unlike database languages, OWL makes an open-world assumption about its knowledge base. If some fact or property is not known to be true then that fact or property is not automatically considered to be false. Also, reasoning in OWL is monotonic, if a fact is concluded to be true then it cannot later be retracted to become false. Sometimes the open-world assumption can be unintuitive, especially in cases where the complements of classes are involved. For example, defining a class as the class of objects that do not have a certain property will lead to an empty class (unless there are cardinality restrictions on the property). For instance, if a property is not defined for a certain instance, reasoning based on open-world assumption will conclude in the future that this property may be defined either through reasoning about the existing knowledge base or through addition of information to the knowledge base. OWL also does not have a unique names assumption. Two instances of a class is the same unless they are specifically stated not to be.

As mentioned, the main Apache configuration file httpd.conf is a plain text file and the file simply contains a laundry list of directives. As also mentioned, a directive is a “command” or “instruction” to the Apache runtime to respond or behave in a certain (directed) way. It is important to set the directives appropriately so that Apache is “well behaved”, for example, from a security perspective.

A first step to modeling the Apache configuration comprises comprehending the overall structure of the main configuration file httpd.conf. There is no inherent structure to the content of the configuration file because the file httpd.conf simply contains a laundry list of directives. The only high level structure that is explicitly commented in the default httpd.conf are the three different sections of directives: global environment; main server configuration; and virtual host configuration.

The global environment section of the httpd.conf file structure contains directives that affect the overall operation of the Apache server. The main server configuration section contains directives that set up the main server to respond to requests that are not handled by a virtual host. The virtual host configuration section contains directives that set up virtual hosts which allow Web requests to be sent to different IP addresses or hostnames and have them handled by the same Apache server process.

Terminologies inspired by the CC international standard are used during the modeling of the invention in order to induce added structure into the understanding of the Apache configuration. The Common Criteria (CC) is a know international standard (ISO/IEC 15408) for specifying, developing and evaluating the security requirements of a system. The CC provides a common set of concepts that can be used for specifying security functional components of Web applications. The target of evaluation (TOE) in the CC is the system or component or application that is under the CC evaluation process. For instance, the Apache server and the Web application that is running under the Apache server can be a TOE.

With respect to a TOE, the CC defines the following concepts. A subject is an active entity in the TOE and a subject performs operations or actions in the TOE. An object is a passive entity in the TOE. A subject typically performs some action on one or more objects. A user is an active entity outside of the TOE.

In this exemplary embodiment of the invention, the Tbox of the Apache configuration is modeled as follows. First directives are identified that influence subject, object, and user aspects of the Apache server. Referring to FIG. 2, at the root of the hierarchy is the owl:Thing 10 which is the base class for all OWL classes. Then four main classes of the CROWTbox are defined: crow:Subject 12; crow:Object 14; crow:ExternalEntity 14; and crow:SupportEntity 16. The first three enumerated classes correspond to directives that influence the subject, the object, and the external entities (users) aspect of the Apache server. The directives that influence the subject aspect of Apache server are specialized under crow:Subject 12. For example, crow:Server 20 and crow:Applications 22 are specializations of crow:Subject 12. Directives are similarly identified that influence the object aspect of the CC and specialize them as sub-classes of the crow:Object 14. For instance, directives that influence files 24, ports 26, sockets 28, etc. are modeled as specialization of the crow:Object class 14. Similarly directives that influence external entities such as the users 30 and groups 32 are modeled as specialization of the crow:ExternalEntity 16.

For the three sections defined in the default httpd.conf file (see above), a SectionSettings 34 class is created that specializes the Settings class. Then, three specializations classes of the SectionSettings 34 are created. As mentioned above these are: MainServerSettings 36, VirtualHostSettings 38, and GlobalServerSettings 40.

In addition to modeling the physical structure of the file, it is also convenient to categorize the httpd.conf file based on directive types. A dual view of the httpd.conf file is created since either view may be advantageous depending on the application. In this structure, another subclass of Settings is created called DirectiveSettings 42 which in turn is classified into HostContainer 44, DirectoryContainer 46, FileContainer 48, and GlobalServerSettings 40, as before. In effect, this structure categorizes the elements of the httpd.conf file based on the <Virtual Host>, <Directory>, and <File> directives. Conceptually, GlobalServerSettings 40 will contain global directives that pertain to the server itself. These include serverRoot, serverTokens, and listen directives. The HostContainer maps to the <Virtual Host> directive and also contains the settings of the default host even though within the actual httpd.conf file these are specified outside of a Virtual Host> container, since structure-wise they are generally equivalent. The DirectoryContainer 46 class corresponds to both the <Directory> and <Location> directives. Finally, the FileContainer 48 class corresponds to the File directive.

In CROW, other objects and subjects that appear within the system are modeled as first class elements. For example, objects such as File, Path, Database, Table, Column, Link, Port, Socket, Module, Location are directly encoded as first class object elements in CROW. Server, Application and other external entities are modeled as first class subjects. User, Group, and other named objects are also modeled as first class external entities. By modeling these resources as OWL classes rather than as string data type, aliasing between objects can then be naturally handled. Also, by modeling as OWL classes, it is ensured that they are kept consistent with the Common Criteria Vocabulary. It also provides a uniform way for describing other types of applications that exists, for example, within a data center. Therefore, later on, when such applications are modeled there will be a common way of defining their interfaces. Finally, modeling subjects and objects as classes conforms with the OWL framework of ontologies and relationships between classes and instances of classes.

As mentioned, the Abox contains instances of Tbox classes and assertions about specific instances that can relate an instance to a class or relate two instances with each other. Tbox instances can be created, for example, by manually using the Protègè tool. These instances will then conform to the constraints of the model. A system administrator can then synthesize the htppd.conf file from these instances, and the resulting configuration file can be expected to be consistent with respect to the model. Often, system administrators do not have the patience (or in most cases, expertise) to deal with an ontology tool for generating the httpd.conf file. So the invention provides a simple Perl tool to parse an existing httpd.conf file and then generate an OWL XML file that represents the Abox for CROW. The resulting XML file is imported into the Protégé tool. Then consistencies of the imported configuration instances are checked. In other words, the invention takes a bottom-up approach for checking consistency of existing httpd.conf file of an installed Apache server.

The invention follows a few modeling principles to simplify reasoning in CROW. Recall that OWL does not uses the unique names assumption. To implicitly construct unique names, an id property is used that is functional and is unique for each instances of non-disjoint classes. This id property will effectively model unique-names assumptions for such instances used implicitly during the reasoning process. Intuitively, this essentially creates a “unique name” for each instance of the class associated with this property in the Abox.

OWL's open world assumption can sometimes complicate the modeling process. In the Apache server example, the set of ports listened to by a virtual host must be a sub-set of the set of ports listened to by the server. This can be expressed in the httpd.conf file. Often, modeling this using the “open world assumption” can lead to some confusion. For example, a property called isListenedToBy is created that relates an instance of a Port class with an instance of a HostContainer class or an instance of a ServerContainer class. It is then desired to restrict the set of ports listened to by an instance h of HostContainer to be a subset of the set of ports listened to by an instance s of ServerContained. With open world assumption, when a new port p is created that is not listened to by s but is listened to by h, the reasoner will simply relate p as being listened to by s. Rather it is desired that the reasoner trigger an inconsistency error in this case. To enable such inconsistencies an “enumerated” sub-class of the Port class is created for those ports that are restricted to be listened to by some instance of the ServerContainer. Such enumerated classes behave like closed-world classes which can be used to track such inconsistencies.

Now, in accordance with the present exemplary embodiment of the invention, the CROW consistency checking rules for the Apache configuration are discussed. Consistency checking rules in CROW essentially comprise imposing restrictions on the elements of Tbox and the properties in Abox. The ultimate goal of such consistency checking rules is that bad practices and insecure directive settings in the httpd.conf file will lead to inconsistencies in the CROW model. Recall that the httpd.conf file is parsed, converted to instances of classes in Tbox, and the instances are imported as elements of Abox. Whenever these imported Abox instances do not meet the constraints and restrictions of the elements of Tbox and properties in Abox, the reasoner will trigger inconsistencies in the model. For example, two classes may be specified to be disjoint, and yet an instance in the Abox is defined to be a member of the two disjoint classes. This is clearly inconsistent with the model and the reasoner will return an inconsistency error. In practice, most inconsistencies stem from the fact that a class and its complement must be disjoint and then deriving that an instance is a member of both such classes. The below Table 1 presents a subset of the exemplary consistency checking rules that have been implemented by the invention in CROW. Since both the open world assumption and no unique names assumptions are followed in our model, the error messages presented by the Pallet reasoner are often not very intuitive. Thus, most errors are either due to the fact that an instance cannot be a member of both a class and its complement, or that a functional property has more than one value.

TABLE 1
Consistency rules and checks

| Consistency Check | Tbor Class | OWL Assertion | Test Case |
|---|---|---|---|
| Error Log is not located | HostSettings | Necessary Condition: | documentRoot /usr/apache |
| inside Document | | not (errorlog some (isin some ( some | errorLog /usr/apache/error-log |
| Root or any | | Location))) | |
| aliased Directory. | | | |
| Only CGI Directories | NotCGIDirectories | Necessary and Sufficient Condition: | documentRoot /usr/local/apache |
| or directories | | Path | <Directory /usr/local/apache> |
| within CGIDirectories | | not CGIDirec | options ExecCGI |
| have the | | isDirectlyIn some (cgidirec has notCGIDirectory) | <Directory> |
| Exe:CGI | | Necessary Condition: | |
| | | cgidirec has notCGIDirectory | |
| | | pathAssociatedWith only (options only (not | |
| | | {Exe:CGI})) | |
| Access Control for | Unspecified | Disjoint With | documentRoot /usr/local/apache |
| Document Root | | isDocumentRootOf some HostSettings: | does not appear in a |
| is specified in | | | <Directory> directive |
| .comf file | | | |
| Every Server has | ServerProperties | Necessary Condition: | serverRoot /usr/local/apache |
| exactly 1 Server- | | serverRoot exactly 1 | serverRoot /usr/apache/local |
| Root defined | | | |
| All Ports listened | PortListenedToBy | Necessary and Sufficient Condition: | <VirtualHost > |
| to by Hosts are | PortListenedTo- | Port and isListenedToBy some ServerContainer | . |
| listened to by the | ByHost | {enumeratedinstances} | . |
| Server. | | (Host)Necessary and Sufficient Condition: | . |
| | | Port and isListenedToBy some HostContainer | <VirtualHost> |
| | | {enumeratedinstances} | no Listen directive |
| | | (Host)Necessary Condition: | for this port |
| | | PortListenedToByServer | |
| Besides for root | Not-Aliased | Necessary and sufficient Condition: | documentroot /usr/local/apache |
| directory. non- | | Path | <Directory /usr/apache/local> |
| aliased directories | | not AliasedDirec | . |
| are not specified in | | isDirectlyIn some (aliasedirec has notAliased- | . |
| .conf (if it is | | Direc) | . |
| probably an error in | | Necessary Condition: | <Directory> |
| directory name). | | aliasdirec has notAliasedDirec | |
| | | Disjoint With | |
| | | {enumeratedinstances} (SpecifiedPath: | |
| | | root directory) | |
| Every Server has | ServerProperties | Necessary Condition: | serverSig On |
| exactly 1 Server- | | serverSig has Off | serverTokens Full |
| Root defined | | serverTokens has Pred | |

During the development of CROW according to the invention, it was observed that there are certain best practices that cannot naturally be expressed using the base OWL DL. It was desirable to confine CROW reasoning to be decidable, and yet more expressive than the base OWL DL. We then explored the possibility of using OWL DL Safe Rules, introduced by Motik et al (see, “Query Answering for OWL DL With Rules”, Journal of Web Semantics, 3(1):41-60, 2005), which combines OWL DL and function free Horn clause in a certain decidable way.

Because OWL DL allows use of the existential quantifier, the existence of instances can be inferred and this can lead to an infinite chain of instances. So a reasoner that just enumerates all instances and checks for consistency may never halt. However, SHOIN(D)'s very restrictive structure allows it to maintain its decidability property. It is simpler to observe the restrictions imposed on SHOIN(D) by translating DL restrictions into Horn Clause syntax. A Horn clause is a disjunction of literals with at most one positive literal. A typical Horn clause is of the form p̂q̂ . . . ̂r→z. There can only be a tree-structure relationship between the variables in the Horn clauses. This restrictive tree structure is what enables SHOIN(D) to be decidable even though an infinite number of instances may be created. An example of a consistency checking rule that is not tree-structured in CROW is the Apache's policy for propagating directory permissions. The way a directory permissions are decided in Apache is that initially, Apache checks whether a directory's permissions have been specified within the httpd.conf file. If not, Apache traverses the directory tree structure until it finds the nearest ancestor whose permissions have been defined within the configuration file. In this case, the directory at hand inherits those permissions of its ancestor. Clearly, this rule is not tree-structured because a “triangle” relationship will have to be created between the path, its ancestor and the user who we are defining permissions for. A simplified version of the above permission rule is given below: UnSpecifiedPath(?x)̂isDirectlyIn(?x, ?y)̂allowFrom(?y, ?a)→allowFrom(?x, ?a).

DL safe rules are Horn Rules, where each variable in the rule occurs in a non-DL-atom in the rule body. These rules allow the extra expressivity of non-tree-structured relationships between variables and yet even in combination with OWL DL still maintain the decidability property. A predicate O that is not part of the description logic is chosen. The predicate is applied to each individual in the Abox and for DL-Safe rules, each variable in a rule appears in an atom that comprises this predicate. Intuitively, this creates a closed-world policy only for those individuals that are directly participating in the rules. However, the existential operator can still be used to infer existence of individuals within the model. These inferences can actually affect the way the rules are applied, although the inferred individuals do not appear explicitly in the rules. Therefore, adding DL-Safe Rules is not equivalent to just enforcing a closed world policy on the total reasoning. The resulting hybrid of DL and DL-Safe Rules is decidable. The following is an example of OSR implemented according to an embodiment of the invention in CROW: UnSpecifiedPath(?x)̂isDirectlyln(?x, ?y)̂associatedWithDirectory(?z, ?y)̂allowFrom(?z, ?a)̂associatedWithDirectory(?b, ?x)→allowFrom(?b, ?a).

Currently there is no open-source reasoner available for the combined reasoning. The invention uses, for example, SWRL rules and a SWRL Rule Engine called Jess to add rules to the CROW model. SWRL is integrated with the OWL knowledge base by defining an atom C(x) to be true if x is an instance of the class description C. An atom P(x, y) is true if x is related to y by the property P. Additionally, only variables that occur in the antecedent of a rule may occur in the consequent (a condition usually referred to as “safety”). This safety condition does not, in fact, restrict the expressive power of the language (because existentials can already be captured using OWL's someValuesFrom restrictions), but it will allow the invention to reason about the decidability of the combined OWL-DL and DLSafe rules language. Currently, the way OWL interfaces with the SWRL Rule engine is that the DL Reasoner and the Rule Engine run in tandem. When the Rule Engine is initiated, the relevant individuals, classes, and properties are exported to the Rule Engine. Then the Rule Engine runs and the new knowledge it outputs is imported into the Abox of DL model. Then the DL Reasoner is initiated and reasons on the combination of Abox and Tbox, new inferences are made and then the Rule Engine can run again. In general, the above tandem process is less expressive than a combined OSR reasoner.

The broad scope of the invention contemplates a CROW-like tool for checking configurations of integrated applications in the context of a large data center. The invention explored the possibility of using modeling languages such as CIM (Content Information Model) and UML (Unified Modeling Language). However, these modeling languages are either informal or semi-formal and typically require procedural logic or custom solvers for reasoning about the models. Thus, in the exemplary embodiment, OWL, OSR, and the off-the-shelf tools are utilized.

The invention provides framework of CROW for modeling and analysis, by way of example, of the Apache configuration. The CROW framework is based by following the CC classification of the elements of the target of evaluation, i.e., the Apache server. Most often a configuration file (such as httpd.conf) simply comprises commands or instructions that control the various aspects of a system (such as the Apache server). The CROW brings out an important principle for modeling and analysis of configurations: one can characterize and categorize the commands and instructions in a configuration file to follow the basic principle of the CC functional components. Therefore it is easy to apply CROW to other application domains, such as applications running in a data center, by simply following the CC TOE and classifying the elements (directives) in a configuration accordingly. Another important implication of following the CROW principle is that a general vocabulary and an ontology (e.g., based on OWL) is created for configuration of any system that is expected to go through the CC evaluation.

Several unit test cases of Apache configurations were written to verify modeling approach of the invention. In particular, herein modeled are the best practice rules given by Sinz et al (see, “Verifying CIM Models of Apache Web-Server Configuration”, QSIC '03: Third International Conference on Quality Software, 290-297, IEEE computer Society Press, 2003). Sinz et al uses Common Information Model (CIM) framework for modeling and verifying configuration properties of the Apache servers. CIM Schemas are represented by UML Diagrams. Association classes are used to model relationships between objects. Although, CIM is a popular modeling language for data modeling, it is a semi-formal model, unlike OWL. Sinz et al. define a custom formal semantics by mapping their CIM to a logic that is inspired by description logic. Unfortunately, the resulting logic is not decidable. Also Sinz et al. wrote a custom reasoner and constraint solver for analyzing the consistency properties of the Apache configuration. The invention uses the off-the-shelf modeling tool Protégé with off-the-shelf reasoner Pellet and Jess. The logic utilized is confined to a decidable sub-set that includes OWL-DL and OSR. Table 2 below shows the CIM model and the CROW model for the set of best practices given by Sinz et. al.

TABLE 2
Comparing CROW and CTM model

| Constraint | CTM Model | CROWModel |
|---|---|---|
| Tag ServerRoot | ∃⁻¹ ServerProperties.ServerRoot | (ServerProperties)Necessary Conditions: |
| property is defined | | serverRoot exactly 1 |
| exactly once (per | | associatedWebServer exactly 1 |
| server) | | |
| MinSpareServer is | [ServerConfiguration](Server Properties.MinSpareServer | SWRL Rule: |
| less than MaxSpare | <Server Properties.MaxSpareServer) | ServerProperties(?x) [symbol] |
| Server | [symbol] [ServerConfiguration](Server Properties.MaxSpareServer | minSpareServer(?x, ?y) [symbol] |
| | > 1) | maxSpareServer(?x, ?x) [symbol] |
| | | lessthanorequal(?x, ?x) [symbol] Global(?a) [symbol] |
| | | badMinMax(?a, “true”) |
| | | ServerProperties(?x) [symbol] |
| | | maxSpareServer(?x, ?y) [symbol] |
| | | lessthanorequal(?y, ?l) [symbol] Global(?a) [symbol] |
| | | badMax(?a, “true”) |
| | | (Global)Necessary Conditions: (there will always |
| | | be exactly one instance of global in the Abox) |
| | | badMinMax has “false” |
| | | badMax has “false” |
| Each host | \|HostProperties.ServerName\| = | serverName property: |
| has its own unique | \|HostConfiguration.Name\| | domain: HostProperties |
| server names | | range: Name |
| | | functional |
| | | inverseFunctional |
| Error Log should | [HostProperties] | Necessary Conditions: |
| not be sacred in | [symbol] PrefixOf(HostProperties.DocumentRoot, | net (errorlog some ( some( some |
| DocumentRoot or a | HostProperties.ErrorLog) | Localized))) |
| subdirectory | | |
| Tag addressport | [HostConfiguration]HostProperties. < | [ServerNecessary and Sufficient Conditions: |
| pair of each | HostAddress.HostPort >⊂ListenSetting. < | Pcct and isListenedToBy some ServerContainer |
| host must be | ListenAddress.ListenPort > | {enumeratedinstances} |
| an addressport | | (Host)Necessary and Sufficient Condition: |
| the Web-server is | | Pcct and inListenedToBy some HostContainer |
| listening to | | {enumerated instances} |
| | | (Host)Necessary Condition: |
| | | PcctListenedToByServer |
| A configurance | ∃ServerProperties.ConfigName | (ServerProperties)Necessary Conditions: |
| name and PID file | [symbol] ∃ServerProperties.PIDFile | configName min 1 |
| must be specified | | pIDFile min 1 |
| for the Web-server | | associatedWebServer exactly 1 |

The invention easily and intuitively express all of Sinz et al. rules in CROW. The invention also extends some of the Sinz rules in a way that is simple in the present model but cannot be done in the Sinz framework. For example, the invention changed the rule that Error Log cannot be located inside Document Root, to Error Log cannot be located inside any aliased Directory. Since Sinz et al. does not model the Directories themselves, but only the names of directories as strings, Sinz is unable to express this more general property. Additionally, CROW reasoning is decidable, unlike the CIM model of Sinz et al. Although one can envision security best practices that cannot easily be expressed using decidable logic, it is believed that in practice this may not be an issue. Finally, Sinz et al. do not follow the CC principle for classifying and modeling configuration. The approach of the invention using the CC classification principle can help standardize vocabulary and ontology for modeling configurations.

The invention presents the framework of CROW that follows the principle of the CC for classifying the elements (directives) of the Apache configuration. An off-the-shelf tool and reasoner are used for modeling and analysis of configurations. Herein, several well known best practices were modeled for configurations and used to analyze extant production-level Apache configurations. Few inconsistencies were found in the configuration files, including innocuous ones. The invention extends CROW to modeling and analyzing configurations of interdependent systems, such as applications running a data center.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams and tables depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for treating consistency checking of a configuration of an information technology system, the method comprising:
developing a model of the configuration based on common criteria functional requirements;
extending the common criteria to model the configuration;
imposing a set of constraints on the configuration model;
converting the system configuration to a model instance; and
verifying that the model instance satisfies the set of constraints.

2. Method of claim 1, wherein said developing comprises:
viewing the information technology system as a set of components that adheres to the common criteria functional requirements;
viewing configurations as a set of commands or instructions that control or influence one or more components; and
classifying the commands and instructions according to the components that it controls or influences.

3. Method of claim 2, wherein said developing further comprises:
modeling the commands and instructions as nodes of a configuration modeled as a graph structure;
modeling dependencies among instructions and commands as edges of the graph structure; and
imposing constraints on the graph structure, nodes, and edges.

4. Method of claim 1, wherein said developing further comprises:
modeling best practices and anti pattern rules on configurations as constraints on the configuration model; and
parsing and converting configuration files automatically to model instances.

5. Method of claim 3, wherein said developing further comprises:
mapping the configuration graph structure into a decidable logic;
wherein the decidable logic comprises description logic and decidable inference rules.

6. Method of claim 1, wherein said developing further comprises:
proving or disproving whether configuration is consistent using decidable logic and making inferences and deductions on the consistency.

7. Method of claim 1, wherein said developing comprises using formal decidable description logic.

8. Method of claim 1, wherein said converting comprises writing a parser configured to convert the configuration to instances of the model.

9. Method of claim 1, further comprising:
extending the common criteria to handle graph dependencies;
applying a common criteria evaluation to the graphical structure; and
validating with respect to the constraints.

10. A system for checking consistency of a configuration of an information technology system, the system comprising:
computing devices and a network;
wherein at least one of the computing devices is configured to develop a model of the configuration based on common criteria functional requirements;
wherein at least one of the computing devices is configured to extending the common criteria to model the configuration;
wherein at least one of the computing devices is configured to impose a set of constraints on the configuration model;
wherein at least one of the computing devices is configured to convert the system configuration to a model instance; and
wherein at least one of the computing devices is configured to verify that the model instance satisfies the set of constraints.

11. An article comprising machine-readable storage media containing instructions that when executed by a processor enable the processor to treat consistency checking of a configuration of an information technology system, wherein the system comprises computer servers, mainframe computers, and user interfaces, the instructions for facilitating:
developing a model of the configuration based on common criteria functional requirements;
extending the common criteria to model the configuration;
imposing a set of constraints on the configuration model;
converting the system configuration to a model instance; and
verifying that the model instance satisfies the set of constraints.
